(19) United States
(12) Patent Application Publication
(10) Pub. No.: US 2017/0213202 A1
(43) Pub. Date: Jul. 27, 2017

(54) Method and Apparatus for a Retail Shopping Facility Including Optional Use of A 3D Scanner

(71) Applicant: Wal-Mart Stores, Inc., Bentonville, AR (US)

(72) Inventors: Donald R. High, Noel, MO (US); Charles P. Kaufman, Lowell, AR (US); Michael D. Atchley, Springdale, AR (US)

(21) Appl. No.: 15/411,018

(22) Filed: Jan. 20, 2017

Related U.S. Application Data
(60) Provisional application No. 62/286,267, filed on Jan. 22, 2016.

(51) Int. Cl. G06Q 20/20; G06Q 30/02; G06Q 30/06

(52) U.S. Cl. CPC G06Q 20/208; G06Q 30/0633; G06Q 30/0279

(57) ABSTRACT

Generally speaking, pursuant to these various embodiments a retail shopping facility contains various items available for purchase. A corresponding memory stores registered ownership information provided at least in part by a consumer in conjunction with purchasing a retail item at the retail shopping facility. A corresponding control circuit provides a possession-transfer opportunity by which an owner of the retail item can offer possession of the retail item to another party. When the owner of the retail item selects that possession-transfer opportunity for the retail item, the control circuit uses the registered ownership information to offer possession of the retail item to other parties who may be potentially interested in possessing the retail item.

### CROSS-REFERENCE TO RELATED APPLICATION

This application claims the benefit of U.S. Provisional Application No. 62/286,267, filed Jan. 22, 2016, and is incorporated herein by reference in its entirety.

### TECHNICAL FIELD

These teachings relate generally to retail point-of-sale facilities.

### BACKGROUND

Retail shopping facilities provide a venue and opportunity for consumers to view, physically interact with, select, and purchase any of a wide variety of items. In most cases the items sold through such facilities are new. In some cases the purchaser keeps the purchased item for the entire useful life of that item. In other cases, however, the purchaser (or other recipient of the item, such as one who receives the item as a gift from the purchaser) will reach a point where they no longer wish to possess the item.

There are a number of options available by which the person possessing such an item can terminate that possession. This person can, for example, simply throw the item away. Contributing to burgeoning landfills, however, is frequently a suboptimum choice.

As another example, this person can donate the item to a thrift shop or the like in the hopes of ultimately benefiting a corresponding charity. Concerns can arise, however, as to whether the item will be sold for an appropriate price (i.e., a sufficiently high price) to ensure that the person's charitable intent is most fully realized.

And as yet another example, this person can attempt to sell the item themselves. Garage sales, on-line auction sites, and newspaper-based or on-line classified advertisements are some traditional mechanisms by which the original purchaser can attempt to locate a willing buyer for their item. Each of these approaches, unfortunately, can consume consider time and effort to correctly and accurately formulate, initiate, monitor, and consummate. Such requirements can discourage many people from opting for this approach.

### BRIEF DESCRIPTION OF THE DRAWINGS

The above needs are at least partially met through provision of the possession-transfer opportunity described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a flow diagram as configured in accordance with various embodiments of these teachings; and

FIG. 4 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments a retail shopping facility contains various items available for purchase. A corresponding memory stores registered ownership information provided at least in part by a consumer in conjunction with purchasing a retail item at the retail shopping facility. A corresponding control circuit provides a possession-transfer opportunity by which an owner of the retail item can offer possession of the retail item to another party. When the owner of the retail item selects that possession-transfer opportunity for the retail item, the control circuit uses the registered ownership information to offer possession of the retail item to other parties who may be potentially interested in possessing the retail item.

By one approach the consumer registers their purchase of the retail item at the retail point-of-sale facility at which the purchase occurred. By another approach the consumer registers their purchase of the retail item at another place and/or time using, for example, a browser-based interface, a mobile app, or the like. By one approach the consumer must register their purchase within a predetermined period of time of when they purchased the retail item.

When registering the purchase these teachings will accommodate receiving one or more items of information from the consumer and/or from a purchase record that is otherwise available to the control circuit. This information can include, if desired, an identifier that is unique (or at least partially unique) to the retail item.

These teachings will accommodate various approaches with respect to registration. As one example, purchaser can be provided with an opportunity to register either themselves as the owner of the retail item or to register another person as a gift recipient (and hence future owner) of the retail item.

The aforementioned possession-transfer opportunity can include verifying that the person is the registered owner of record. By one optional approach the possession-transfer opportunity can also include providing an opportunity for the owner to provide one or more visual images of the retail item. By one approach this image can comprise a two-dimensional and/or a three-dimensional image of the retail item. By one approach the retail shopping facility itself includes a three-dimensional scanner that can serve in these regards.

If desired, these teachings will accommodate permitting the party to select from amongst various corresponding options. For example, by one approach the party can select whether they wish to sell the retail item to another party or to rent the retail item to another party. By another approach, in lieu of the foregoing or in combination therewith, the possession-transfer opportunity can include the opportunity to select directing the proceeds that are received when transferring possession of the retail item to another party to a charity.

When creating the corresponding offer to transfer possession these teachings will accommodate using the aforementioned registered owner information as well as other product information that may be available to the control circuit.

So configured, these teachings can greatly ease the process by which a purchaser can later transfer possession of their purchased items. These teachings are highly flexible in practice and will accommodate a variety of modifications in the foregoing regards to suit the needs of various application settings.

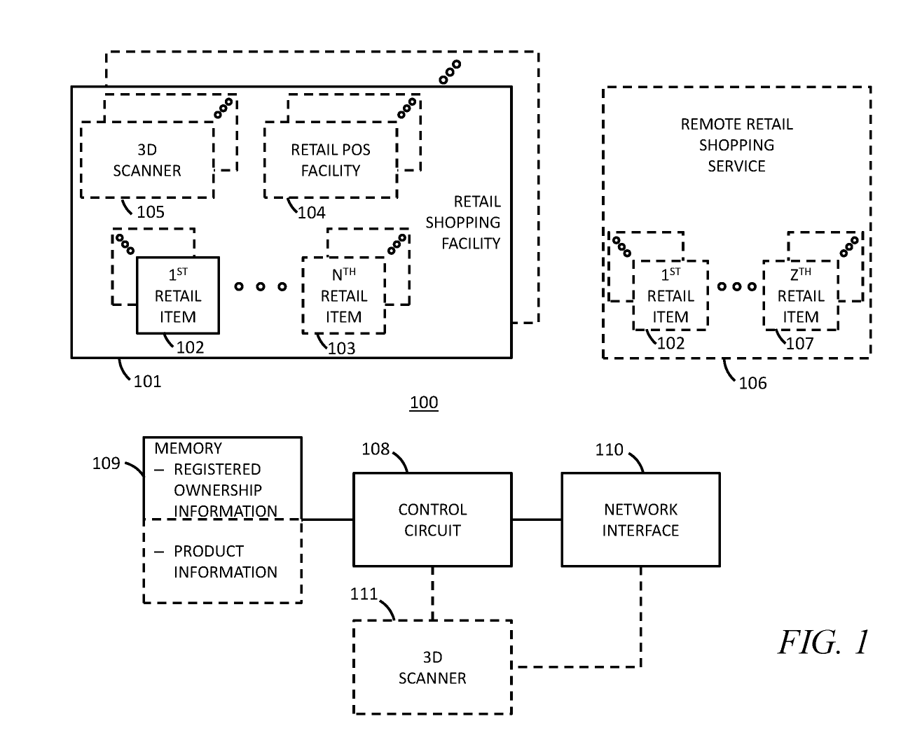

These and other benefits may become clearer upon making a thorough review and study of the following detailed description. Referring now to the drawings, and in particular to FIG. 1, an apparatus 100 that is compatible with many of these teachings will now be presented.

In this illustrative example the apparatus 100 includes at least one retail shopping facility 101. Each retail shopping facility 101 comprises a retail sales facility or any other type of bricks-and-mortar (i.e., physical) facility in which products are physically displayed and offered for sale to customers who physically visit the facility. For the sake of this example the retail shopping facility 101 includes at least one of a first retail item 102 and may further include up to Nth additional retail items 103 (where N is an integer greater than 1). A typical retail shopping facility 101 will likely offer thousands or even hundreds of thousands of such items 102, 103. Some of these items may be perishable and have only a relatively short useful life while other items may be very durable with a useful life of many years or even decades.

The shopping facility may include one or more of sales floor areas, checkout locations (i.e., retail point-of-sale (POS) facilities 104), customer service areas other than checkout locations (such as service areas to handle returns), parking locations, entrance and exit areas, stock room areas, stock receiving areas, hallway areas, common areas shared by merchants, and so on. The retail shopping facility 101 may be any size of facility, and may include products from one or more merchants. For example, a facility may be a single store operated by one merchant or may be a collection of stores covering multiple merchants such as a mall.

In this illustrative example the retail shopping facility 101 may also include one or more three-dimensional scanners 105. This three-dimensional scanner 105 may be stationed within the retail shopping facility itself and hence may be configured and designed to operate therein, or may comprise a part of a mobile platform (such as a van, truck, or trailer) that is a part of the retail shopping facility services but which may be temporarily moved to various locations, such as a consumer's residence, to facilitate its use. Various three-dimensional scanners are known in the art. As the present teachings are not particularly sensitive to any particular choices in these regards, further elaboration regarding three-dimensional scanners is not provided here for the sake of brevity.

If desired, the apparatus 100 may also optionally include a remote retail shopping service 106. This remote retail shopping service 106 may comprise, for example, one or more servers or the like that offer an on-line shopping service to consumers via, for example, a browser-based interface, a mobile app interface, or the like. This remote retail shopping service 106 may offer some items such as the aforementioned first retail item 102 that are also available at the retail shopping facility 101. These teachings will also accommodate having the remote retail shopping service 106 offer one or more items 107 that are not available at the retail shopping facility 101 and vice versa.

It will be presumed here that a control circuit of choice carries out many of the actions, steps, and/or functions described herein. FIG. 1 provides an illustrative example in these regards.

In this particular example, the enabling apparatus 100 includes such a control circuit 108. Being a “circuit,” the control circuit 108 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 108 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 108 is configured (for example, by using corresponding programming as will be well understood by those skilled in the art) to carry out one or more of the steps, actions, and/or functions described herein.

By one optional approach the control circuit 108 operably couples to a memory 109. This memory 109 may be integral to the control circuit 108 or can be physically discrete (in whole or in part) from the control circuit 108 as desired. This memory 109 can also be local with respect to the control circuit 108 (where, for example, both share a common circuit board, chassis, power supply, and/or housing) or can be partially or wholly remote with respect to the control circuit 108 (where, for example, the memory 109 is physically located in another facility, metropolitan area, or even country as compared to the control circuit 108).

In addition to storing registered ownership information (and, optionally, product information) as described herein, this memory 109 can serve, for example, to non-transitorily store the computer instructions that, when executed by the control circuit 108, cause the control circuit 108 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 108 also operably couples to a network interface 110. So configured the control circuit 108 can communicate with other elements (both within the apparatus 200 and external thereto) via the network interface 110. Network interfaces, including both wireless and non-wireless platforms, are well understood in the art and require no particular elaboration here.

Also, if desired, the control circuit 108 can operably couple to a three-dimensional scanner 111. This three-dimensional scanner 111 may be the same as, different from, or in addition to the three-dimensional scanner 105 described above. Generally speaking, this three-dimensional scanner 111 can serve to scan retail items that a previous purchaser or gift recipient now wishes to transfer pursuant to these teachings.

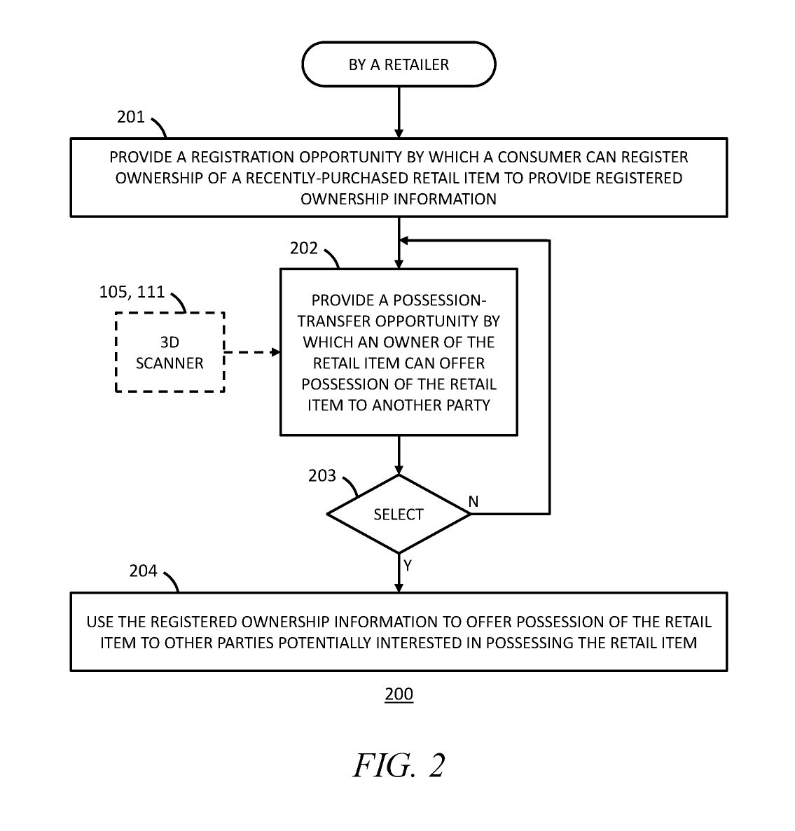

With continued reference to FIG. 1 and referring now also to FIG. 2, an illustrative process 200 that is compatible with many of these teachings will now be presented.

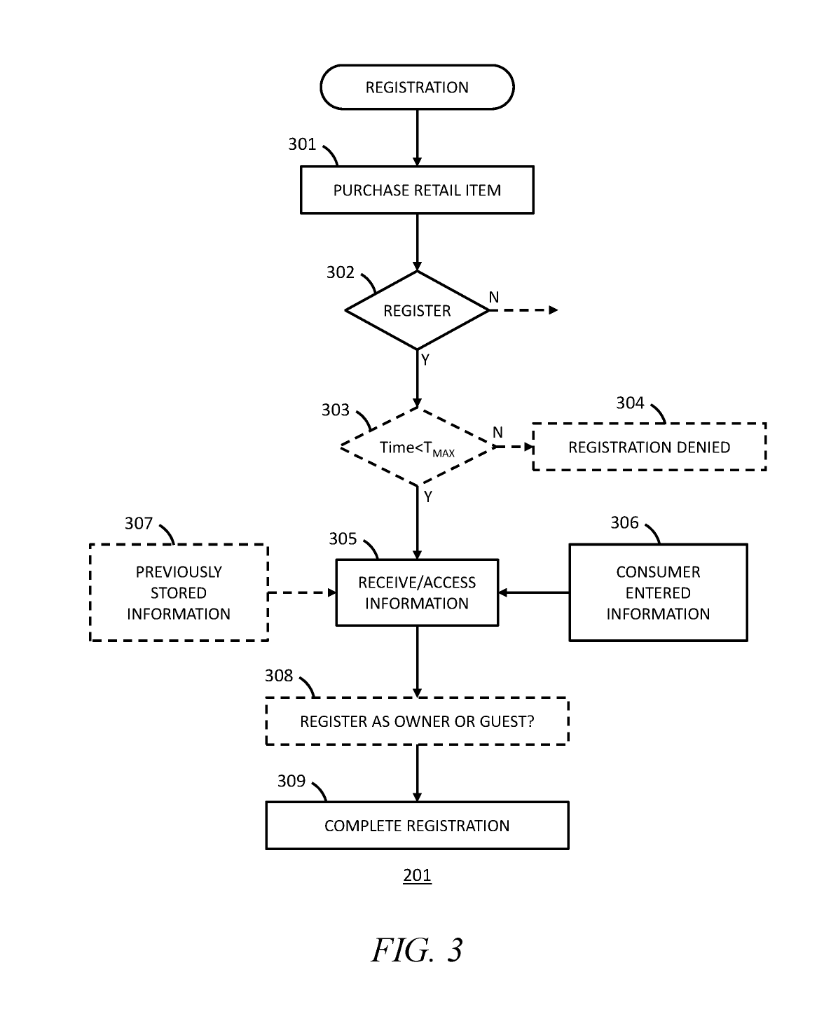

Pursuant to this process 200, at block 201 a retailer provides a registration opportunity by which a consumer can register ownership of a recently-purchased retail item to provide registered ownership information that can be stored in the aforementioned memory 109. FIG. 3 provides more specifics in these regards.

At block 301 of FIG. 3, a consumer purchases a particular retail item. By one approach, this purchase occurs within the retail shopping facility 101 at, for example, the aforementioned retail point-of-sales facility 104. By another approach, this purchase occurs via the aforementioned remote retail shopping service 106.

At block 302, the purchaser engages (directly or indirectly) an opportunity to register this purchase. (If the purchaser elects to forgo this opportunity, this process 201 can be momentarily paused or concluded as desired.) By one approach the purchaser so registers the purchase as a separate, discrete activity. By another approach, if desired, this registration process can occur as a background activity. For example, information regarding the purchaser (identification information such as a name, for example, from their provided credit information and/or their proffered loyalty indicia) can be automatically combined with information regarding the purchased item (as comprises a part, for example, of a virtual receipt or other proof of purchase) and then automatically stored as the aforementioned registration information.

By one optional approach, at block 303 the control circuit determines whether the purchaser is seeking to register the purchase within a predetermined period of time (for example, within T_{MAX} which can be any period of time such as 1 day, 1 week, 1 month, or other duration of choice). If the registration attempt occurs outside the permitted timeframe, at block 304 the registration attempt can be denied. These teachings will accommodate taking other actions or offering alternative actions to the purchaser if desired under these circumstances.

At block 305 this process 201 provides for receiving and/or accessing information pertaining to the purchased retail item. This information can comprise, for example, information 306 entered by the consumer. This consumer-entered information may comprise an identifier that is unique to the retail item (such as a model number and/or serial number). These teachings will accommodate receiving other information as well, such as a stock keeping unit (SKU) number, a corresponding radio-frequency identification (RFID) tag identification number, a brand-specific or generic name for the item, item color, whether the item was purchased with corresponding accessories, and so forth.

These teachings will also accommodate optionally receiving (or linking to) other previously stored information 307. Examples in this regard include any of the above-mentioned items of information as well as other product descriptions and technical specifications, professional and consumer reviews, explanatory and/or instructional still images or videos, owners/operators manuals, assembly instructions, maintenance instructions, and so forth.

By one optional approach, at block 308 this process provides the purchaser with an opportunity to register either themselves or a gift recipient or other guest as the owner of the purchased retail item. That registration information can be included with the aforementioned registered ownership information. This identification information can include any or all of a person's name, a residential or email address, a telephone number, a personal identification number (PIN) or other code or password, and so forth as desired.

At block 309 the registration process completes.

Referring again to FIGS. 1 and 2, at block 202 this process 200 provides a possession-transfer opportunity by which an owner of the retail item can offer possession of the retail item to another party. This possession-transfer opportunity can be provided immediately upon consummation of the corresponding purchase of the retail item or can be delayed by some predetermined period of time if desired. By one approach the predetermined period of time can be established by the enterprise that operates the retail shopping facility 101. By another approach the predetermined period of time can be established, at least in part, by the purchaser themselves. For example, these teachings will accommodate permitting a purchaser to require that a gift recipient of the item forestall selling that item for at least some minimal period of time such as one year.

Generally speaking, and as will be described in more detail below, by one optional approach these teachings will accommodate receiving one or more three-dimensional images of the retail item as provided by any of the aforementioned three-dimensional scanners 105, 111 (or any other three-dimensional scanner that may be available for these purposes).

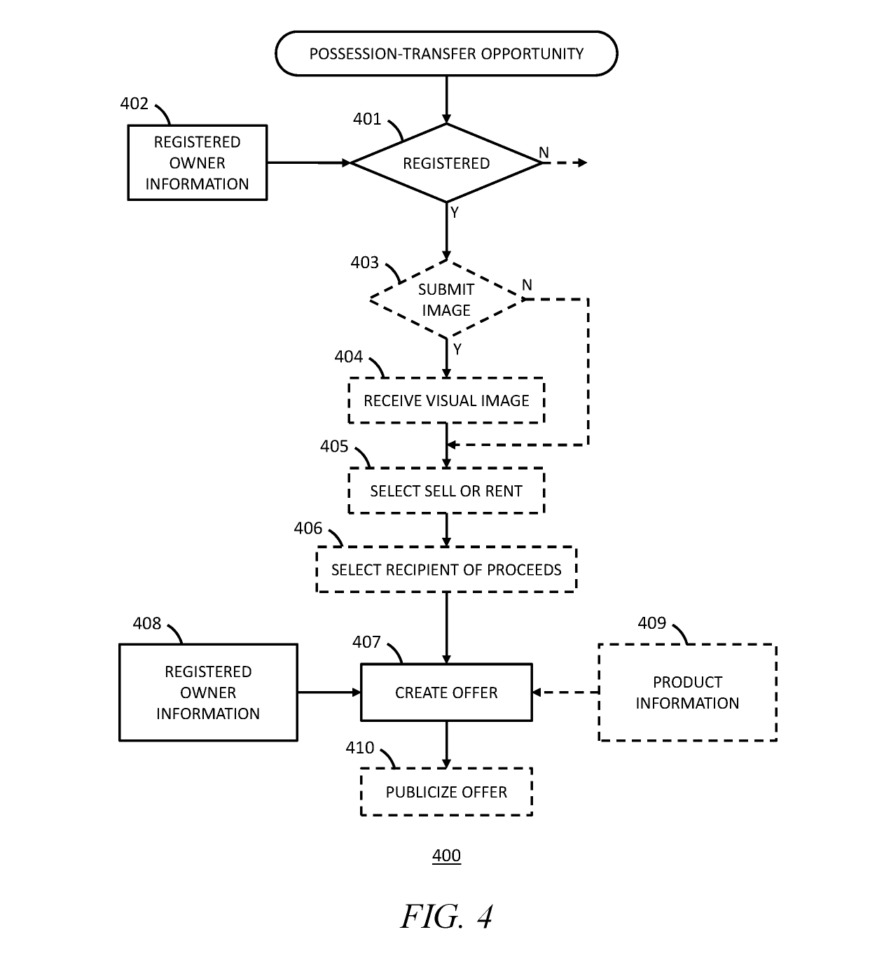

At block 203, selection of the possession-transfer opportunity is detected and followed, at block 204, by use of the aforementioned registered ownership information to offer possession of the retail item to other parties potentially interested in possessing the retail item. FIG. 4 offers further details as regards the possession-transfer opportunity.

With specific reference to FIGS. 1 and 4, this process 400 can begin with determining, at block 401, whether the owner of the item previously registered their ownership (or had that status registered by, for example, the original purchaser). This determination can be based, for example, upon the aforementioned registered owner information 402. When such is not the case, this process 400 can divert as desired. By one approach, for example, the possession-transfer opportunity can simply be denied. By another approach, the owner can be diverted to an alternative process whereby an offer to transfer possession of the item can be arranged via a different set of constraints and/or requirements.

Upon confirming prior ownership registration, by one approach and as illustrated at block 403 and 404 this process 400 can include providing an opportunity for the owner to provide at least one visual image of the retail item. This visual image can comprise, if desired, a two-dimensional or three-dimensional image of the retail item. That three-dimensional image can be created, in turn, by one or more of the above-described three-dimensional scanners 105, 111. In lieu thereof or in combination therewith these teachings will also accommodate receiving other images that are sourced by the owner or that are otherwise provided to the control circuit 108. By one approach this visual image can comprise a current image; i.e., an image that depicts the current physical and/or operating condition of the item.

By one optional approach, at optional block 405 this process 400 can provide the owner with the option of transferring possession by selling the retail item to another party or, in the alternative, by renting the item to another party. Other approaches, such as a combination rent-to-buy approach can be accommodated as well if desired.

By another optional approach, at optional block 406, the owner can be provided with an opportunity to select directing the proceeds that are received from transferring possession of the retail item to another party (either via sale of that item or by rental of that item) to another party such as, for example, a charity. This opportunity can be as generic or specific as desired. For example, charitable causes can be generically described (for example, “animal welfare” or “supporting the homeless”) or specifically identified (for example, “The Buddy Foundation” or “The Salvation Army”).

At block 407 this process 400 provides for creating the corresponding offer to transfer possession of this particular item. In addition to whatever information the owner provides per the above described interactions this offer creation can make use of the aforementioned registered owner information 408 and/or other product information 409 that may be available to the control circuit 108 as described above.

This offer can include an asking price for the item. That asking price can be specified by the owner. By another approach, the enterprise can specify a particular resale price or can establish a minimum and/or a maximum price at which the item can be offered. By yet another approach the owner can be permitted (or required) to select or utilize an auction-based approach to establishing the sales price of the item.

At block 410 the aforementioned offer can be published. By one approach this can comprise including the offer via an on-line mechanism (for example, in conjunction with the aforementioned remote retail shopping service 106). By one approach this offer can be placed in conjunction with an offer to sell a new version of the same (or a similar) retail item. This publicized offer can be relatively sparse in terms of information or can be relatively rich in detail and content as desired. By one approach the offer can include a link that, when selected, leads the reader to additional details and information regarding the item, terms and conditions of sale or rental, shipping requirements or conditions, and so forth.

Such an offer, when acted upon by an interested purchaser, can lead to a consummated sale via the same service that publicizes the offer (for example, the above-mentioned remote retail shopping service 106). Accordingly, details regarding the purchaser, the shipping address, and payment can be handled by that service. By one approach the present owner of the item is notified when a sale is consummated and is provided with shipping information. Using this approach the present owner then arranges to ship or otherwise deliver the item to the purchaser (or renter, as the case may be). By another approach, if desired, the service that facilitates the offer and sale can also itself arrange for delivery of the item, either via its own resources or via selected delivery service resources of choice.

So configured, a purchaser of a new item has the comfort and advantage of being able to easily and readily arrange for a future transfer of possession of their item. The enterprise may itself participate in the economic return of such resale activity (for example, by requiring an appropriate handling and/or service fee) or can offer this service without charge to the owner as desired. By one approach this service can be offered without additional cost to persons who have a particular established relationship with the retailer (such as, for example, a particular recognized loyalty level, an enterprise-branded credit card, and so forth).

By one approach these teachings can greatly leverage information the enterprise may already possess (or readily acquire) at the time of originally selling the item. That information can later be utilized when describing the item in the offer to transfer possession. That information may also be helpful when automatically calculating a suggested resale price (or a range of resale prices).

Those skilled in the art will recognize that a wide variety of modifications, alterations, and combinations can be made with respect to the above described embodiments without departing from the scope of the invention. As one example in these regards, the owner can be provided with an opportunity to select whether the transfer of possession is limited to a particular geographic area (such as a particular municipality, state, or country). As another example in these regards, these teachings will accommodate automatically selecting or suggesting a resale price based upon a variety of other information, such as seasonal variations, current events, relative scarcity or availability of the item in question, and so forth. Accordingly, such modifications, alterations, and combinations are to be viewed as being within the ambit of the inventive concept.

What is claimed is:

1. An apparatus comprising:
a retail shopping facility;
a memory having stored therein registered ownership information provided at least in part by a consumer in conjunction with purchasing a retail item at the retail shopping facility;
a control circuit operably coupled to the memory and configured to:
provide a possession-transfer opportunity by which an owner of the retail item can offer possession of the retail item to another party;
when the owner of the retail item selects the possession-transfer opportunity for the retail item, use the registered ownership information to offer possession of the retail item to other parties potentially interested in possessing the retail item.

2. The apparatus of claim 1 wherein the memory also has stored therein registered ownership information provided at least in part by a consumer in conjunction with purchasing a retail item via a remote retail shopping service.

3. The apparatus of claim 1 wherein the control circuit is configured to provide the possession-transfer opportunity, at least in part, by providing an opportunity for the owner to provide at least one visual image of the retail item.

4. The apparatus of claim 3 wherein the at least one visual image comprises a three-dimensional image of the retail item.

5. The apparatus of claim 4 further comprising a three-dimensional scanner at the retail shopping facility, wherein the control circuit is configured to receive the three dimensional image of the retail item via the three-dimensional scanner.

6. The apparatus of claim 1 wherein the control circuit is configured to provide the registration opportunity by which a consumer can register ownership of a recently-purchased retail item to provide registered ownership information, at least in part, by providing the consumer with an opportunity to register either themselves or a gift recipient as the owner of the retail item.

7. The apparatus of claim 1 wherein the possession-transfer opportunity by which an owner of the retail item can offer possession of the retail item to another party comprises at least one of:
a possession-transfer opportunity by which an owner of the retail item can sell the retail item to another party; and
a possession-transfer opportunity by which an owner of the retail item can rent the retail item to another party.

8. The apparatus of claim 1 wherein the control circuit is configured to use the registered ownership information to offer possession of the retail item to other parties potentially interested in possessing the retail item by, at least in part, offering possession of the retail item in conjunction with an offer to sell a new version of the retail item.

9. The apparatus of claim 1 wherein the possession-transfer opportunity includes an opportunity to select directing proceeds received from transferring possession of the retail item to another party to a charity.

10. A method comprising:
by a retailer:
providing a registration opportunity by which a consumer can register ownership of a recently-purchased retail item to provide registered ownership information;
providing a possession-transfer opportunity by which an owner of the retail item can offer possession of the retail item to another party;
when the owner of the retail item selects the possession-transfer opportunity for the retail item, using the registered ownership information to offer possession of the retail item to other parties potentially interested in possessing the retail item.

11. The method of claim 10 wherein the registration opportunity is only provided during a predetermined period of time that corresponds to when the consumer purchased the retail item.

12. The method of claim 10 wherein the consumer purchased the retail item at one of:
a retail point-of-sale (POS) facility;
a remote retail shopping service.

13. The method of claim 10 wherein providing the possession-transfer opportunity includes providing an opportunity for the owner to provide at least one visual image of the retail item.

14. The method of claim 13 wherein the at least one visual image comprises a three-dimensional image of the retail item.

15. The method of claim 14 wherein providing the opportunity for the owner to provide at least one visual image of the retail item includes providing at the retailer a three-dimensional scanner for scanning the retail image to thereby provide the visual image of the retail item.

16. The method of claim 10 wherein providing a registration opportunity by which a consumer can register ownership of a recently-purchased retail item to provide registered ownership information includes providing the consumer with an opportunity to register either themselves or a gift recipient as the owner of the retail item.

17. The method of claim 10 wherein the possession-transfer opportunity by which an owner of the retail item can offer possession of the retail item to another party comprises at least one of:
a possession-transfer opportunity by which an owner of the retail item can sell the retail item to another party; and
a possession-transfer opportunity by which an owner of the retail item can rent the retail item to another party.

18. The method of claim 10 wherein using the registered ownership information to offer possession of the retail item to other parties potentially interested in possessing the retail item includes offering possession of the retail item in conjunction with an offer to sell a new version of the retail item.

19. The method of claim 10 wherein the registration opportunity includes registering an identifier that is unique to the retail item as part of the registered ownership information.

20. The method of claim 10 wherein the possession-transfer opportunity includes an opportunity to select directing proceeds received from transferring possession of the retail item to another party to a charity.
